(19) United States
(12) Patent Application Publication
(10) Pub. No.: US 2002/0198781 A1
(43) Pub. Date: Dec. 26, 2002

(54) Reward allocation in information-access system

(75) Inventor: Paul Michael Cobley, Alton Hants (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/173,148

(22) Filed: Jun. 18, 2002

(30) Foreign Application Priority Data
Jun. 22, 2001 (GB) 0115458.2

(51) Int. Cl. G06F 17/60

(52) U.S. Cl. 705/14

(57) ABSTRACT

A method is provided of allocating reward in a system that provides user access to multiple information resources including reward-associated information resources such as advertiser websites accessed through banner ads on a website controlled by the system operator. The method involves detecting user access to any of the reward-associated information resources, and thereupon making a random determination of the period of time a user must use the accessed resource before being entitled to a reward. The reward can, for example, be credit against further use of the system.

### FIELD OF THE INVENTION

The present invention relates to a method and arrangement for reward allocation in an information-access system.

### BACKGROUND OF THE INVENTION

It is well known for portal websites and other websites not tied to promoting a single company, to sell advertising space to third parties, this space often taking the form of so-called ‘banner ads’. Upon a user clicking on a banner ad, they are generally taken to a related page of the website of the third party advertiser concerned (this is often effected either by opening a new web-browser window or by pulling the linked third-party page into a frame of the current window, since either approach retains the presence of the original website). The amount of advertising revenue that can be collected usually depends on the magnitude of the traffic visiting the site or system hosting the banner ads and may also depend on the number of click-throughs to the advertiser's own site; appropriate mechanisms for collecting the relevant statistics are well known in the art.

It is clearly in the interest of the operator of the ad-hosting system to encourage click-throughs to the advertisers' websites. One way of doing this is to reward a user each time they click-through a banner ad to an advertiser's website (though usually a maximum level set on rewards that can be collected in this way). The reward can, for example, be credit for continued use of the system concerned, this being particularly appropriate where the system is an internet cafe workstation for which the user has normally to pay to use. However, such an arrangement is open to abuse as a user can collect the reward simply by clicking on banner ads and then immediately returning from or closing the resultant page delivered from the advertisers site.

It is an object of the present invention to provide a reward allocation method that is less susceptible to misuse.

### SUMMARY OF THE INVENTION

According to one aspect of the present invention, there is provided a method of allocating reward in a system that provides user access to multiple information resources, the method involving the steps of:

(a) detecting user access to any of a group of one or more of said information resources that are set as reward-associated information resources, and generating a related access indication;

(b) in response to the generation of an access indication, making a random determination of a minimum usage period of the accessed resource that is required before the user is to be allocated a reward; and

(c) determining whether the user uses the accessed resource for the determined minimum usage period and, if so, effecting a reward allocation to the user.

It is to be understood that as used herein reference to detecting access to an information resource includes detecting an access request.

According to another aspect of the present invention, there is provided, in a system providing user access to multiple information resources, a reward allocation subsystem comprising:

an access detection arrangement responsive to a user accessing any of a group of one or more of said information resources that are set as reward-associated information resources, to output an access indication; and

a reward determination arrangement comprising:

a random determination arrangement, responsive to the output of an access indication by the access detection arrangement, to make a random determination of a minimum usage period of the accessed resource that is required before the user is to be allocated a reward; and

a reward-allocation arrangement for determining whether the user uses the accessed resource for the determined minimum usage period and, if so, effecting a reward allocation to the user.

### BRIEF DESCRIPTION OF THE DRAWINGS

Embodiments of the invention will now be described, by way of non-limiting example, with reference to the accompanying diagrammatic drawing, in which:

FIG. 1 is a diagram of an internet cafe incorporating a reward allocation arrangement.

### BEST MODE OF CARRYING OUT THE INVENTION

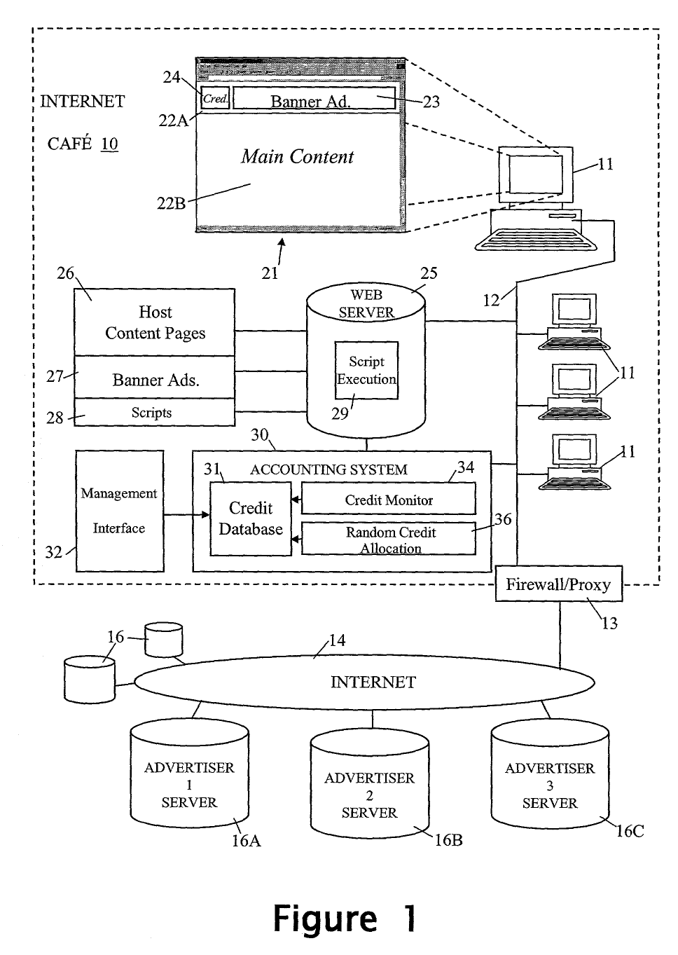

FIG. 1 depicts an internet café 10 in which a plurality of workstations 11 are connected via a LAN 12 and gateway 13 (acting as a firewall/web proxy) to the public internet 14 in order to access information resources typically constituted by web pages served by HTTP servers 16. A person (customer) wishing to use a workstation 11 pays a certain amount to the operator of the internet cafe and is given a corresponding level of credit for use of one of the workstations. The initial credit amount is set into a credit database 31 of an accounting system 30 via a management interface 32. The customer is also given a logon name and password and each time the customer logs on or off a workstation, the accounting system is informed enabling it to keep a record, in database 31, of the current logged on/off status of each user together with the identity of the workstation concerned. At regular and frequent intervals corresponding to the time for a logged-on user to use up a unit (or sub-unit) of credit, credit monitor 34 scans the database 31 and decrements the credit amount associated with each currently logged-on user. A logged-on user's remaining credit amount is continually displayed to the user at their workstation concerned. When the credit monitor detects that no credit remains, it initiates compulsory log-off of the user from the workstation. The accounting system 40 is implemented by appropriate programs running on a general purpose computer.

After a customer logs on to a workstation 11, an installed web browser displays a start page 21 retrieved via LAN 12 from a web server 25 run by the operator of the internet café 10. Start page 21 comprises, for example, a header frame 22A and a main content frame 22B. Within the header frame are areas 23 and 24 respectively for displaying banner ads 27 and the current credit level of the user, this typically being done through the use of applets loaded from server 25. The main content frame initially displays an instruction page with links to index pages of useful external sites, these pages 26 being downloaded from the web server 25. As well as hosting the content pages 26 and banner ad applets 27, the web server 25 also provides a script execution environment 29 for running various script files 27 in response to request messages from the workstation browsers.. In order to ensure that the contents of the header frame 22A are always visible, it can be arranged that all new content pages fetched by the browser are displayed in the main content frame 22A regardless of any instruction embedded in a currently displayed page, or the new page, that the new page should be displayed differently (that is, in a different frame, in the full browser window, or in a new browser window). Other approaches can be used to ensure that at least the banner ads 23 remain visible at all times to the user as will be understood by persons skilled in the art.

Clicking on a banner ad 23 results in the loading of a page retrieved over internet 14 from the website 16A, B or C of the advertiser concerned.

Systems for implementing internet cafes of the above general form (or equivalent) are well known in the art and accordingly further details of these aspect of the FIG. 1 system will not be given.

In the present arrangement, whenever a customer clicks through a banner ad to retrieve a page from the website of the advertiser concerned, a random determination is made regarding the allocation of a reward to the customer, this reward here being in the form of extra credit for using a workstation 11. By introducing a random factor into reward allocation, the potential for abuse is reduced.

One way of making the reward determination is to determine whether or not the user is to be immediately allocated a credit reward, a positive determination resulting in the generation of a reward instruction to the credit database 31 to increase the credit of the customer concerned by an appropriate amount. The way this is achieved is as follows. When the customer clicks on a banner ad 23, an HTTP request message is sent to the server 25 in respect of a related script file 28 which is then loaded into execution environment 29 and run. An identifier of the customer is included in the request message.

The script running in execution environment 29 uses a random credit allocation functional block 36 of the accounting system 34 to determine whether or not the customer has been allocated a credit reward; if so, the script sends back a response to the customer's workstation in the form of a credit reward notification. This notification includes an embedded timed redirection instruction that after a predetermined time causes the workstation browser to fetch the advertiser's page associated with the banner ad clicked on by the customer. If a reward is not allocated to the customer by the random credit allocation block 36, the script simply returns a response with an embedded redirection instruction intended for immediate execution to retrieve the advertiser's page.

The random credit allocation functional block 36 is for example, implemented as a script function that can be called by the main script running in execution environment 29. This function is, for example, arranged to make a random number choice over a preset range with only one number corresponding to a credit reward allocation. Of course, more than one number can be designated as a “winning” number, potentially with a different reward amount being associated with each such designated number. Changing the preset range over which the random determination is made will, of course, alter the chances of the customer being allocated a reward. It is possible to arrange for this preset range to be set in dependence on the banner ad (and thus advertiser) concerned; this would be useful as a way of encouraging preferential click through on banner ads of particular advertisers who had arranged with the internet café operator that there should be a greater chance of being rewarded by clicking through on their banner ads.

The random credit allocation block can also be arranged to randomly determine the size of any credit reward, this being either done for all banner-ad click-throughs or only where the block has already determined that a reward is to be allocated. An upper limit is preferably placed on the size of the credit reward.

A drawback with the foregoing random reward allocation method is that a customer knows immediately whether clicking a banner ad has resulted in a reward allocation and they therefore have not incentive to dwell on the advertiser's page retrieved by clicking the banner ad. To overcome this drawback, rather than the random determination made by the random credit allocation block 36 (in response to being called by the main script executing in environment 29) being of whether a reward is to be immediately awarded, the random determination made by block 36 is of a time period for which a customer must have the advertiser's page loaded in their browser before receiving a credit reward. The randomly determined time returned to the main script is then used to set up a timing applet that is then embedded in a two-frame page which the script causes to be returned to the workstation concerned. This two-frame page comprises a first, minimal, frame in which the timing applet is embedded, and a second, main, frame into which the advertiser's page is pulled. Provided this two-frame page remains loaded for the timing period of the applet (that is, the randomly determined time period) the timing applet is arranged to send a message back to the server 25 causing a credit allocation to the customer (for example, via the execution of an appropriate script). Other ways of implementing this random-load-time reward allocation are, of course, possible—for example, by tracking what pages the customer loads to determine how long they retain pages from the advertiser's website.

It will be appreciated that the random reward allocation block can be arranged to randomly determine, in respect of a banner ad click-through, both whether a reward is available and, if so, the minimum loaded period of the advertiser's page that is required before the customer is allocated a reward.

It will be appreciated that many variants are possible to the above described arrangements. For example, rather than the rewards being in terms of usage credits, they can take the form of access to privileged resources.

Of course, the random reward allocation feature can be applied to systems other than internet cafes, such as to portal websites or other sites that rely on advertising revenue from banner ads. It will also be appreciated that the advertisements need not be in the form of web browser banner ads and could, for example, be advertisements running in an application that is independent of the web browser and displaying as a dedicated area of a display screen. The random reward allocation feature can be applied not only to information resources associated with advertisements but also to any other types of information resource for which it is wished to encourage access by associating a reward.

1. A method of allocating reward in a system that provides user access to multiple information resources, the method involving the steps of:
(a) detecting user access to any of a group of one or more of said information resources that are set as reward-associated information resources, and generating a related access indication;
(b) in response to the generation of an access indication, making a random determination of a minimum usage period of the accessed resource that is required before the user is to be allocated a reward; and
(c) determining whether the user uses the accessed resource for the determined minimum usage period and, if so, effecting a reward allocation to the user.

2. A method according to claim 1, wherein step (b) involves, prior to making said random determination of a minimum usage period, determining whether a reward is available in respect of the access concerned, said random determination of a minimum usage period only being effected in cases where a reward is available.

3. A method according to claim 2, wherein determining whether a reward is available is effected on a random basis with the probability of a reward being available, being set in dependence on the identity of the reward-associated information resource being accessed.

4. A method according to claim 1, wherein the magnitude of any reward that is to be allocated is also randomly determined.

5. A method according to claim 1, wherein the rewards for allocation comprise credit for further use of the system.

6. A method according to claim 1, wherein the rewards for allocation comprise access to privileged resources.

7. A method according to claim 1, wherein the reward-associated information resources are web pages retrieved via banner advertisements on a web page associated with the operator of said system.

8. A method according to claim 1, wherein said system is a portal website.

9. A method according to claim 1, wherein said system is an internet café.

10. In a system providing user access to multiple information resources, a reward allocation subsystem comprising:
an access detection arrangement responsive to a user accessing any of a group of one or more of said information resources that are set as reward-associated information resources, to output an access indication; and
a reward determination arrangement comprising:
a random determination arrangement, responsive to the output of an access indication by the access detection arrangement, to make a random determination of a minimum usage period of the accessed resource that is required before the user is to be allocated a reward; and
a reward-allocation arrangement for determining whether the user uses the accessed resource for the determined minimum usage period and, if so, effecting a reward allocation to the user.

11. In a system according to claim 10, a reward allocation subsystem wherein the random determination arrangement is operative, prior to making said random determination of a minimum usage period, to determine whether a reward is available in respect of the access concerned, said random determination of a minimum usage period only being effected in cases where a reward is available.

12. In a system according to claim 11, a reward allocation subsystem wherein determining whether a reward is available is effected by the random determination arrangement on a random basis with the probability of a reward being available, being set in dependence on the identity of the reward-associated information resource being accessed.
